(19) United States
(12) Patent Application Publication
(10) Pub. No.: US 2008/0172417 A1
(43) Pub. Date: Jul. 17, 2008

(54) Automatic Monitoring and Control of Fill Levels

(76) Inventors: Thomas Oehler, Gengenbach (DE); Franz Harter, Lauterbach (DE); Juergen Fichter, Schiltach (DE); Fridolin Faist, Oberwolfach (DE)

Correspondence Address: FAY KAPLUN & MARCIN, LLP, 150 BROADWAY, SUITE 702, NEW YORK, NY, 10038, US

(21) Appl. No.: 11/966,284

(22) Filed: Dec. 28, 2007

Related U.S. Application Data
(60) Provisional application No. 60/885,040, filed on Jan. 16, 2007.

(30) Foreign Application Priority Data
Jan. 16, 2007 (DE) 10 2007 002 351.2

(51) Int. Cl. G06F 17/30; G05D 9/12

(52) U.S. Cl. 707/104.1; 700/281; 707/E17.009

(57) ABSTRACT

An inventory management system automatic monitors and control of fill levels or pressure states. The inventory management system supports bidirectional communication between the individual field devices and a central system. The bidirectional communication takes place using a web client by way of a communications network (e.g., the Internet) so that broadband data exchange becomes possible. Administration of the measured data takes place centrally and automatically.

### REFERENCE TO RELATED APPLICATIONS

This application claims the benefit of the filing date of German Patent Application Ser. No. 10 2007 002 351.2 filed 16 Jan. 2007 and U.S. Provisional Patent Application Ser. No. 60/885,040 filed 16 Jan. 2007, the disclosure of which applications is hereby incorporated herein by reference.

### FIELD OF INVENTION

The present invention relates to inventory management and the organisation of delivery processes in the field of fill level measuring or pressure measuring. In particular, the invention relates to an inventory management system for the automatic monitoring and control of fill levels or pressure states, and to a method for the automatic monitoring and control of fill levels or pressure states with the use of such an inventory management system.

### BACKGROUND INFORMATION

Nowadays the fill levels of containers or silos can be determined with the use of fill level sensors, and the measured values can be transmitted to higher-order control systems by way of field bus connections. Subsequently, the measured values can be displayed within the local networks. Furthermore, nowadays the acquisition of unit products can be carried out by means of radio frequency identification (RFID). Likewise, there are various logistics tools which by means of available inventory data carry out future forecasts and profitability assessments. Furthermore, these systems provide support in automating various recurrent business processes, for example the exchange of business documents. Generally speaking, web-based call-up of inventory data requires expansions on the browser side, for example the installation of a Java runtime library in order to carry out graphic processing.

However, existing tools may only cover a partial region and may not comprise data interfaces that would make it possible to combine the systems so that they form a functional closed supply chain management chain. In the use of the tools up to now, it may have only been a partial aspect from the supply chain management chain that was of interest. Up to now, graphic display of inventory data by way of internet access required expansions on the browser side, for example the installation of a Java runtime library. Therefore, in that in practical application compatibility problems between the Java script and the runtime may occur.

### SUMMARY OF INVENTION

According to an exemplary embodiment of the present invention, an inventory management system (=overall system) for the automatic monitoring and control of at least one of fill levels and pressure states for example in a storage unit or tank is stated, wherein the inventory management system comprises an inventory acquisition unit (=sensors+evaluation device) for the acquisition of fill level data or pressure data, a central system (=Web-VV server software) and a communication unit (=evaluation device, if need be combined with an external modem), which communication unit is associated with the inventory acquisition unit, for transmitting the fill level data or pressure data to the central system and for receiving control data or regulating data from the central system, in each case by way of the internet, and wherein the central system is designed for central administration and processing of at least one of the fill level data and pressure data.

The inventory management system may be adapted for automatic triggering a filling of the storage unit or tank.

The inventory management system according to an exemplary embodiment of the invention is thus in a position to acquire inventory data (namely fill level data or pressure data) and to transmit this data by way of a communication unit to a central system. In this arrangement transmission is by way of the internet. Serial transmission by way of a modem connection is not required. Instead, in order to bypass this bottleneck, broadband internet may be used. There are also provisions for the option of implementing the connection by way of remote data-transmission connections with the use of the PPP protocol (in other words, serial packet-oriented connection variants by way of telephone networks, and consequently also modems or routers).

In the central system, administration and processing of the inventory data then takes place. Furthermore, the central system may communicate with the communication unit and thus with the inventory acquisition unit, for example it may trigger measured-value polling or it may parameterise a field device.

In this way broadband bidirectional communication between field devices (inventory acquisition devices, i.e. sensors) that are distributed worldwide and a central measured-value management system (central system) is provided.

This may provide an improved provision of measured values and data by way of the internet.

According to a further exemplary embodiment of the present invention, the inventory management system is designed for the automatic acquisition and transfer of the fill level data or pressure data.

Interaction with a user is not required. Instead, the data may be automatically polled by the central system, for example at corresponding pre-set points in time, or based on evaluation of previous events (history).

According to a further exemplary embodiment of the present invention, the inventory acquisition unit comprises at least one inventory acquisition device selected from the group comprising a fill level sensor for acquiring fill level data, a pressure sensor for acquiring pressure data, and an identification sensor for acquiring unit data.

The identification sensor may, for example, be an RFID sensor.

According to a further exemplary embodiment of the present invention, the communication unit is integrated in a corresponding inventory acquisition device.

Several inventory acquisition devices that are distributed worldwide may be provided, each inventory acquisition device comprising an individual communication unit (externally or integrated, as desired). In this way a centrally administered network of field devices may be provided, which network uses the internet as a communication medium.

According to a further exemplary embodiment of the present invention, the communication unit and the central system are designed to transmit the fill level data or pressure data to the central system by way of a local area network (LAN) connection.

According to a further exemplary embodiment of the present invention, for the purpose of transmitting the fill level data or pressure data the communication unit comprises a web client.

For example, the communication unit is designed such that it forwards a measured value received at a first interface to a second interface by means of the web client, where it makes said measured value available.

A web client is a software component which communicates with a web server, usually by way of a network (e.g. the internet). In most cases a web client uses the hypertext transfer protocol (HTTP) for communication with the web server. In the present context the term “web client” also includes a process that is executed as an autonomous unit or in an integrated manner in an overall system on a processor, which process controls communication between two systems. The control information for the behaviour of the web client is taken from stored software.

Furthermore, the control software (referred to as “application”) may be separate from the web client. The web client may thus be the software component that is called up by an application in order to establish an http connection to a web server and in order to carry out data exchange. It is entirely up to the application, i.e. the stored software, to decide whether and when the web client is to become involved.

For example, after a measurement has been carried out the web client can detect that a valid measured value is present. After internal processing of the measured value on the communication unit, said web client can provide said measured value, which is provided by way of a first interface of the communication module or of the communication unit, to a database by way of a second interface. In this arrangement the measured value or further information in conjunction with measuring, for example information relating to device identification and address identification of the measuring device, the time of measurement or the duration of measurement, can be transmitted directly into the database or into a storage device of the database. The database is, for example, located in the central system. The measured values or the other information are/is transmitted to that location by way of the internet.

By using a web client, and thus the available actuating mechanisms for data transfer, the success of a measured-value transmission may be monitored, and in the case of an error the communication module (communication unit) can react accordingly. For example, in the case of an error resulting from faulty transmission that may be caused by transmission interference, the information already sent can be sent again.

According to a further exemplary embodiment of the present invention, the central system comprises a web server with post-connected software components, wherein the software components are designed to receive and store the fill level data or pressure data and/or further information from inventory acquisition devices that are distributed worldwide. In FIG. 5 this functionality is shown in the blocks 506 (Web-VV WEB client), 509 (Web-VV communication service), 510 (Web-VV business server) and 502 (MS SQL server). 506 in concrete terms describes the communication interface in the direction of the communication unit. Among other things 506 represents the functionality of the web server and that of the web client.

According to a further exemplary embodiment of the present invention, the software components are designed as Web-VV software components. In this way, complete integration of various tools to form a closed supply chain management chain may be made possible in that a software program product “Web-VV” by the VEGA enterprise is used, which product has been specially developed for this purpose. As a link, Web-VV can receive inventory information from measuring devices installed worldwide. Further processing may be centrally administered.

According to a further exemplary embodiment of the present invention, the web server is designed to use a script language for receiving and storing the fill level data or pressure data.

The description of an interface by way of a script language may make possible flexible adaptation to a communication partner of the communication device. The communication unit may, for example, provide information that is intended for communication with a database. The requirements concerning the type, order and number of the parcels of information to be transmitted may vary. With the use or description of an interface by means of a script, which can, for example, be loaded into the communication unit and which can, for example, be executed by the communication unit and/or the central system, flexible adaptation to the database may be made possible.

According to a further exemplary embodiment of the present invention, the script language comprises an HTTP protocol. According to a further exemplary embodiment of the present invention, the software component comprises a web-based configuration interface that may make it possible for authorised users to gain external access.

Authorised users that are distributed worldwide can thus in a simple manner directly access the inventory data of the centrally administered field devices by way of the internet.

According to a further exemplary embodiment of the present invention, the inventory management system further comprises a material administration- and logistics control device for further processing the stored fill level data or pressure data.

Linking the central system to the materials administration- and logistics control device can, for example, take place by way of standardised interfaces, for example the so-called OPC interface (OLE for process control) by way of web services or by way of an SQL connection to the database.

The inventory data stored in the central system may be transmitted to the post-connected materials administration- and logistics control device, which may be arranged inside or outside the central system. The materials administration- and logistics control device can also be installed, as a pure software component, on the Web-VV server. However, it is also possible to integrate the two systems by way of a local network even on different PCs or servers. Furthermore, it is possible to operate the materials administration- and logistics control software completely separately from the Web-VV server software at some other location anywhere in the world by way of an internet connection.

According to this further exemplary embodiment of the present invention, the materials administration- and logistics control device is thus situated in a location that differs from that of the Web-VV server and communicates with the Web-VV server by way of the internet connection.

According to a further exemplary embodiment of the present invention, the materials administration- and logistics control device is installed on the Web-VV server.

According to a further exemplary embodiment of the present invention, a method for the automatic monitoring and control of at least one of fill levels and pressure states with an inventory management system is stated in which fill level data or pressure data is acquired by an inventory acquisition unit; the fill level data or pressure data is transmitted by a communication unit, which is assigned to the inventory acquisition unit, to a central system by way of the internet; control data or regulating data is received in the communication unit, wherein the control data or regulating data has been transmitted by the central system to the communication unit by way of the internet; and in which the fill level data or pressure data is managed and processed by the central system.

Furthermore, according to a further exemplary embodiment of the present invention, the method involves forwarding the processed or administered fill level data or pressure data to a materials administration- and logistics control device for further processing of the fill level data or pressure data.

Below, exemplary embodiments of the invention are described with reference to the figures.

### BRIEF DESCRIPTION OF DRAWINGS

FIG. 1 shows a block diagram of an inventory management system according to an exemplary embodiment of the present invention.

FIG. 2 shows a block diagram of an inventory management system according to a further exemplary embodiment of the present invention.

FIG. 3 shows a diagrammatic view of a Web-VV data exchange by way of HTTP.

FIG. 4 shows a diagrammatic view of distributed Web-VV servers according to an exemplary embodiment of the present invention.

FIG. 5 shows functional Web-VV blocks according to a further exemplary embodiment of the present invention.

FIG. 6 shows a flow chart of a method according to an exemplary embodiment of the present invention.

### DETAILED DESCRIPTION

The illustrations in the figures are diagrammatic and not to scale.

In the following description of the figures the same reference characters are used for identical or similar elements.

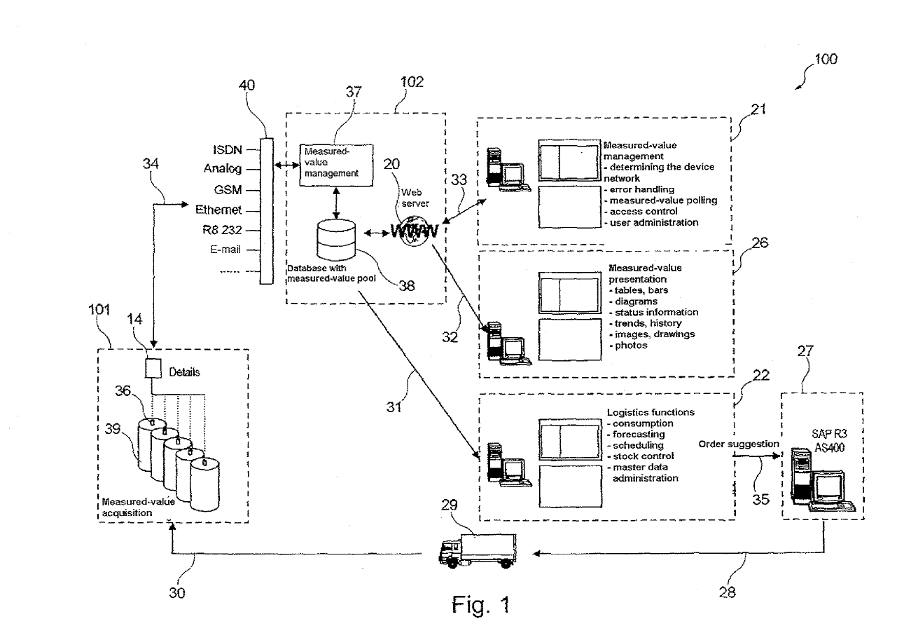

FIG. 1 shows a diagrammatic view of an inventory management system 100 according to an exemplary embodiment of the present invention. The inventory management system 100 comprises an inventory acquisition unit 101, a central system 102 and a measured-value management system 21, a measured-value presentation system 26, and a materials administration- and logistics control unit 22. In each case, communication 31, 32, 33, 34 is by way of the internet.

In particular, communication between the inventory acquisition unit 101 on the one hand, and the central system 102 on the other hand, is bidirectional so that access from the central system 102, for example for targeted polling of the inventory data (pressure data or fill level data) or for triggering a new reading, may become possible.

The inventory management system 100 is used for completely automated implementation of supply chain management in an industrial environment, for example in the foodstuffs sector, the chemical industry, in the field of the construction industry, waste recovery etc.

In particular, the system according to the invention supports supply chain management as far as the material flow is concerned. The system extends to automated acquisition of fill level data and/or pressure data of goods at different locations, wherein the acquired inventory data is stored centrally in the database 38 of the central system 102. Moreover, the stored inventory data is transmitted to post-connected materials administration- and logistics control devices 22 for further processing.

The materials administration- and logistics control devices 22 are provided with suitable rules and instructions so that, depending on the incoming inventory data, among other things, activation of orders can be triggered. It is thus ensured at all times that the inventory of the monitored goods never falls below a minimum, and that no unnecessarily large delivery quantities are built up. This may not need any intervention by a user. The system operates automatically.

If it has been registered that due to a delivery that has been triggered the inventory has been replenished, if need be the dispatch of invoices can be triggered. In addition, web-based access to the stored inventory data is possible at any time, wherein the extent of the data that is visible is governed by way of user rights. Completely processed views in tabular form and in graphics form are available for web-based access.

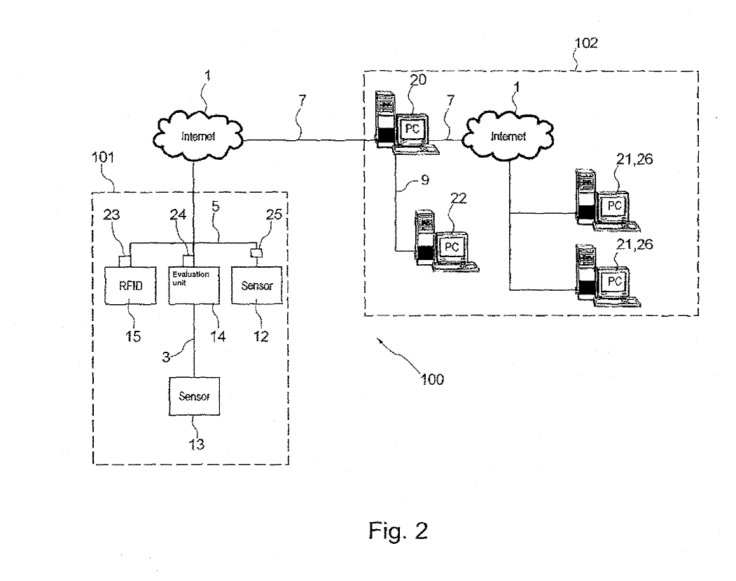

The inventory acquisition unit 101 comprises, for example, a multitude of field devices 36, such as fill level sensors or pressure sensors, which are, for example, incorporated in the tanks 39 and which are used for measured-value acquisition. These field devices 36 are, for example, connected to an evaluation unit 14 that comprises a communication unit 24 (see FIG. 2) or that is connected to such a communication unit 24.

The communication unit can transfer the measured data to the central system 102 by way of the internet 34. For example, for this purpose the use of ISDN, analog telephone connections, GSM, GPRS, Edge, DSL or other broadband connections is provided (see reference character 40). In principle, all the connection variants that support packet-oriented communication of internet protocols can be used. If the communication unit and the central system are directly linked by way of a LAN connection, then a direct Ethernet connection may also be used.

The central system 102 comprises a measured-value management module 37 for the central administration and processing of the fill level data or pressure data, and a database 38 with a measured-value pool in which the measured values can be stored. Furthermore, a web server 20 is provided, by way of which communication between the materials administration- and logistics control devices 22, external measured-value management 21 and one or several external measured-value presentation units 26 takes place.

Among other things the measured-value management module 21 is used to determine the device network (field devices), to handle errors, to poll measured values, to control access and to handle user administration. In effect, measured-value management 21 merely involves a computer with an internet browser. The configuration pages are edited on the computer in the internet browser as web pages. The pages themselves are generated in the central system 102, with the configuration data again being stored in the central system 102.

The measured-value presentation module 26 among other things is used to present the measured values in the form of tables, bars or diagrams, to present status information, to present a trend or a history regarding the measured values, to present information in the form of images, drawings or photos. Measured-value management 26 consists, for example, merely of a computer with an internet browser. The measured-value information is displayed on the computer in the internet browser as web pages. The pages themselves are generated in the central system 102 on the basis of the information stored in the database.

The materials administration- and logistics control device 22 controls, regulates and forecasts the use, for example, of the fill materials, and carries out scheduling, stock control and master data administration. The logistics control device 22 is an autonomous software component.

The logistics tool 22 can automatically provide order suggestions to a corresponding order module 27 by way of a connection 35. The order module 27 can, for example, be SAP R3 AS400. The order unit 27 then triggers inventory replenishment 28, 29, 30 of the corresponding storage container or tank 39 (which is monitored by the corresponding field device 36).

The system is used for the automated acquisition of inventory data relating to goods, which can be distributed worldwide. In this arrangement the provision of inventory data can take place by determining fill levels by way of various fill level sensors. Likewise, this can also take place by acquiring any unit products, for example by way of RFID sensors.

The devices for inventory acquisition share a common feature in that they comprise an internally arranged unit 23, 24, 25 (see FIG. 2) that makes it possible, after a previously defined event has occurred, to establish contact with a central system 102 that is suitable for this purpose, and to transmit the current inventory information to this central system 102. In each case the communication units 23, 24, 25 can be arranged within a corresponding field device or they can be connected to said field device.

A connection by way of the internet 34 may be used for transmitting the inventory information to the central system 102. However, it may also be possible to use a direct LAN connection. The central system 102 comprises a software component that has been developed specifically for this purpose, e.g. the software component “Web-VV” by VEGA, and optionally a commercially available PC. If required, a high-performance server solution can also be used.

By way of suitable interfaces, the software component receives the inventory data of the devices that are distributed worldwide and stores the data in one or several databases 38. For example, by way of a web client contained in the devices, the inventory data is forwarded to a web server that is contained in the software component with the use of the HTTP protocol.

Furthermore, the software component offers a web-based configuration interface that makes it possible for authorised persons to allocate the incoming inventory data to the respective users and projects and/or locations. Furthermore, the software component provides functions for setting up and configuring inventory presentations for additional users. The term “inventory presentations” refers to any presentations of the acquired inventories in graphic or tabular form, e.g. tables with current inventories or historic data, bar charts, pie charts or line diagrams.

In addition, the above-mentioned presentation pages can be made available to any desired users by way of allocating individual user rights in a web-based manner. In other words, authorised users can access the data allocated to them from any location in the world by means of a commercially available internet browser, for example by means of Microsoft Internet Explorer.

Furthermore, the stored inventory data can be fed for further processing to post-connected materials administration- and logistics control devices 22 inside or outside the central system 102. Linking the above-mentioned central system 102 to the materials administration- and logistics control devices 22 can take place by way of standardised interfaces, for example the OPC interface or by way of an SQL connection to the database. The materials administration- and logistics control device can also be installed on the Web-VV server as a pure software component. However, it is also possible to provide the two systems on different PCs or servers by way of a local network. Moreover, there is the option of operating the materials administration- and logistics control software completely separately from the Web-VV server software at some other location anywhere in the world by way of an internet connection.

In each case the materials administration- and logistics control devices 22 are provided with suitable rules and instructions so that, depending on the incoming inventory data, among other things, activation of orders can be triggered. It may thus be ensured at all times that the inventory of the monitored goods never falls below a minimum. If it has been registered that due to the delivery that has been triggered the inventory has been replenished, if need be the dispatch of invoices may be triggered.

FIG. 2 shows a diagrammatic view of the acquisition of inventories by measuring fill level data and/or pressure data according to an exemplary embodiment of the present invention. For this purpose the inventory acquisition unit 101 comprises sensors 13 (fill level sensors or pressure sensors) which forward their measured values by way of a connection 3, optionally by means of a digital bus connection or as an analog 4 . . . 20 mA fill level signal, to a higher-order evaluation unit 14. Furthermore, additional sensors 12 may be provided which do not communicate with the internet 1 by way of the evaluation unit 14. Furthermore, identification sensors 15 (for example RFID sensors) for the acquisition of unit data may be provided.

Corresponding communication units 23, 24, 25 are assigned to the sensors 12, 15 or to the evaluation unit 14, which communication units 23, 24, 25 are either directly integrated in the sensors 12, 15 or in the evaluation unit 14, or which communicate with these devices by way of a corresponding transmission path (by wire or wirelessly).

By way of the internet 1 and a corresponding communication path 7 the measured data is transmitted to the central system 102. The communication connection between the central system 102 and the inventory acquisition unit 101 is bidirectional. It is thus possible to poll the measured values in a targeted manner and to parameterise the individual devices in a targeted manner.

The central system 102 comprises a Web-VV server 20, which is connected to the internet 1 by way of the communication path 7. By way of the internet, data exchange with web browsers 21, 26 distributed worldwide can take place for measured-value presentation or measured-value management.

Furthermore, a logistics tool 22 is provided, for example in the form of a PC with corresponding logistics software, which logistics tool 22, by way of the data transmission path 9, can communicate with the Web-VV server 20 (likewise by wire or wirelessly).

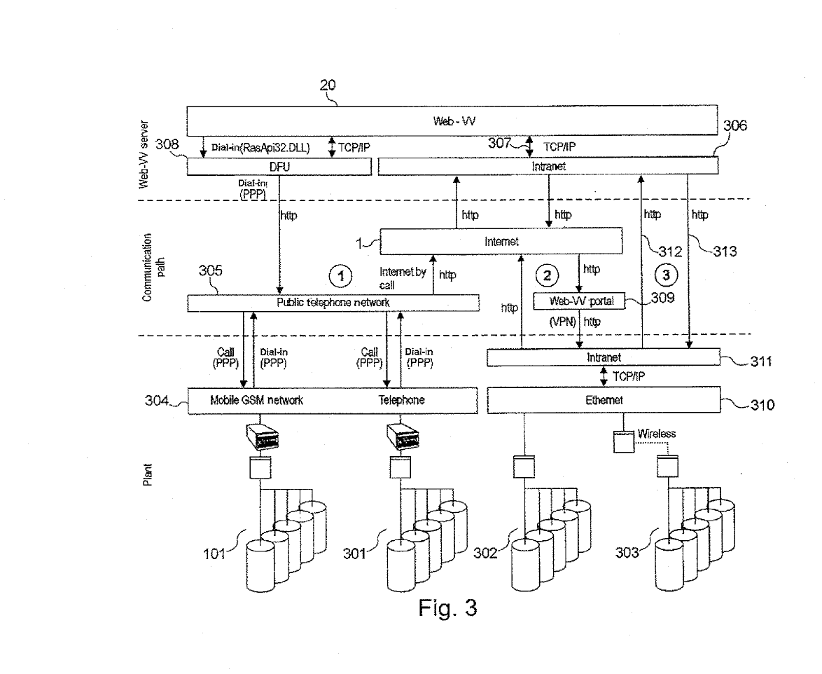

FIG. 3 shows a diagrammatic view of a Web-VV data exchange by way of HTTP. A multitude of inventory acquisition units 101, 301, 302, 303, which can be distributed worldwide, are connected to the Web-VV server 20 by way of an internet connection.

The data exchange takes place, for example, by way of a mobile GSM network or telephone 304, in each case connected to a public telephone network 305. The measured data is then transmitted by way of the public telephone network 305 over the internet 1 by means of the HTTP protocol to an intranet 306. The intranet 306 communicates by way of TCP/IP 307 with the Web-VV 20.

Likewise, the Web-VV server 20 may dial into the public telephone network 305 by way of a remote data-transmission interface 308, and in this way exchange data with the inventory acquisition units 101, 301, 302, 303.

Likewise, a Web-VV portal 309 can be provided which by way of the Ethernet 310 and the intranet 311 can provide a connection from the inventory acquisition units 302, 303 to the internet 1.

Moreover, direct HTTP-communication 312, 313 between the intranet 311 and the Ethernet 310 on the side of the inventory acquisition units and the intranet 306 on the side of the Web-VV 20 is possible.

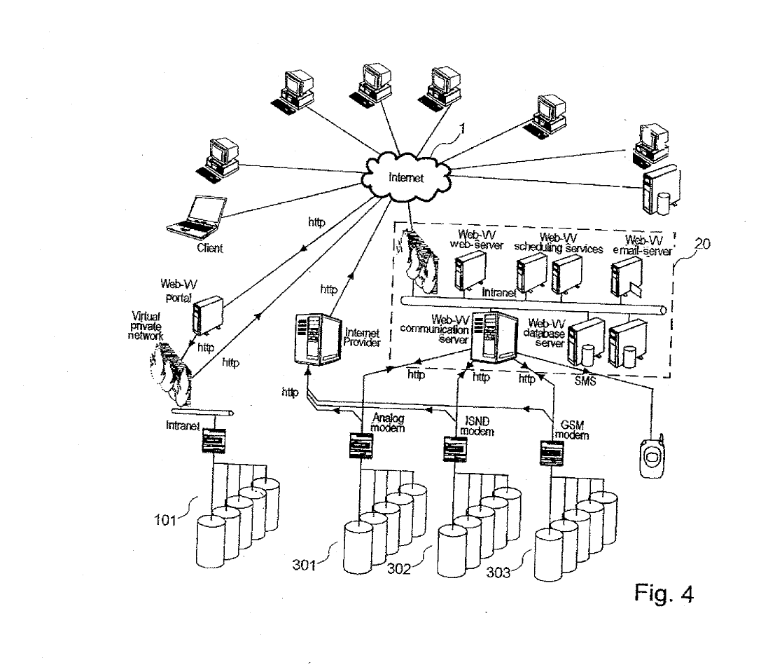

FIG. 4 diagrammatically shows a distributed Web-VV server 20 which communicates with the individual inventory acquisition units 301, 302, 303, 101 by way of the HTTP protocol. The scalability of the Web-VV server software makes it possible, depending on the system's output- and performance requirements, to combine various computer units to form an overall system, wherein each computer unit optimally carries out a sub-task within the overall system.

The following sub-tasks within the system 20 are shown by way of examples:
Web-VV web server
Web-VV scheduling services
Web-VV e-mail server
Web-VV communication server
Web-VV database server

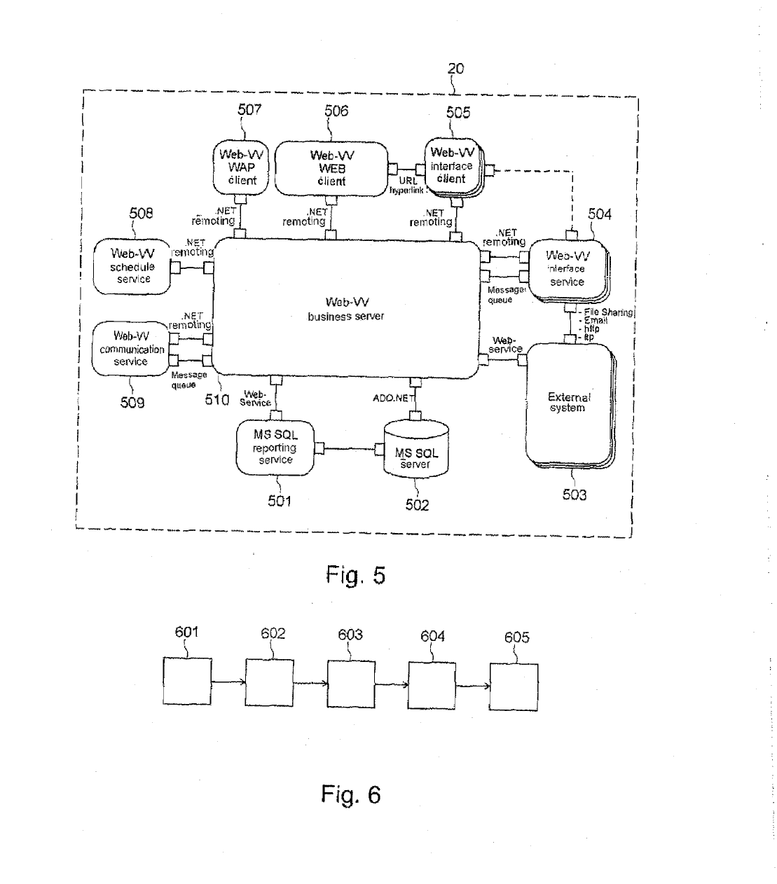

FIG. 5 shows a diagrammatic view of the function blocks of the Web-VV server software. Consistent implementation of component programming allows distributed installation on various computer units, and thus simple and flexible adaptation to the requirements and tasks at hand. Web-VV essentially comprises the software components described below.
MS SQL reporting service 501 describes the software components in which the graphics, line diagrams, bar charts and tabular views are generated.
MS SQL server 502 is the system's database; it comprises all the system data, user data, device data, configuration settings and all measuring data.
External system 503 describes the optimal connection of external software, e.g. of a logistic tool for further processing and evaluation of the data collected and provided by Web-VV. The data exchange can take place directly or by way of the optional Web-VV interface service 504.
Web-VV interface client 505 is used as a standardised interface for any desired web browser, e.g. Firefox or Internet Explorer, and, together with Web-VV web client 506, provides web access to the Web-VV user interface.
Web-VV WAP (wireless application protocol) client 507 provides further optional access to Web-VV.
Web-VV scheduler service 508 controls and monitors the internal procedures of Web-VV business server 510, generates messages and information according to the configuration that has been set, and monitors the entire data transfer of the assigned devices to Web-VV.
Web-VV communication service 509 provides the input interface for the measuring values and data of the assigned devices.
Web-VV business server 510 is the core of the Web-VV server software; it coordinates all the procedures and activities as well as the interaction among the individual components 501-509.

FIG. 6 shows a flow chart of a method for the automatic monitoring and control of fill levels or pressure states in an inventory management system according to an exemplary embodiment of the present invention.

In step 601 the fill level data or pressure data is acquired by an inventory acquisition unit, and thereafter in step 602 said data is transmitted by a communication unit to a central system by way of the internet. In step 603 control data or regulating data, for example for triggering a measuring activity or for parameterising a field device, is transmitted from the central system and is received by the communication unit. The data subsequently measured anew is also transmitted to the central system. Moreover, in step 604 central administration and processing of the fill level data or pressure data is carried out by the central system. In step 605 the processed or administered data is transmitted to a materials administration- and logistics control device for further processing.

The application of the system according to the invention and of the method according to the invention is not limited within an operation for complete supply chain management. Instead, the system according to the invention and the method according to the invention may also be applied above the level of individual plants so as to control supply chain management in diverse customer- and supplier networks.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

What is claimed is:

1. An inventory management system for automatic monitoring and control of at least one of fill levels and pressure states, comprising:
an inventory acquisition unit acquiring at least one of fill level data and pressure data;
a central system centrally administering and preparing at least one of the fill level data and the pressure data; and
a communication unit coupled with the inventory acquisition unit, the communication unit transmitting, via a communications network, at least one of the fill level data and the pressure data to the central system and receiving, via the communications network, at least one of the control data and regulating data from the central system.

2. The inventory management system according to claim 1, wherein the system automatically acquires and transfers at least one of the fill level data and the pressure data.

3. The inventory management system according to claim 1, wherein the inventory acquisition unit includes at least one inventory acquisition device selected from a group comprising a fill level sensor acquiring fill level data, a pressure sensor acquiring pressure data, and an identification sensor acquiring unit data.

4. The inventory management system according to claim 3, wherein the communication unit is integrated in a corresponding inventory acquisition device.

5. The inventory management system according to claim 1, wherein the communication unit and the central system communicate using a Local Area Network.

6. The inventory management system according to claim 1, wherein the communication unit includes a web client.

7. The inventory management system according to claim 6, wherein the central system comprises a web server with post-connected software components, the software components receiving and storing at least one of the fill level data and the pressure data from inventory acquisition devices.

8. The inventory management system according to claim 7, wherein the software components are Web-VV software components.

9. The inventory management system according to claim 7, wherein the web server uses a script language for receiving and storing at least one of the fill level data and the pressure data.

10. The inventory management system according to claim 8, wherein the script language comprises an HTTP protocol.

11. The inventory management system according to claim 7, wherein the software components comprise a web-based configuration interface providing an external access for authorised users.

12. The inventory management system according to claim 1, further comprising:
a materials administration- and logistics control device further processing the stored fill level data and the pressure data.

13. The inventory management system according to claim 12, wherein the materials administration- and logistics control device is situated in a first location, the Web-VV server being situated in a second location being different from the first location, the materials administration- and logistics control device communicating with the Web-VV server using the communications network.

14. The inventory management system according to claim 12, wherein the materials administration- and logistics control device is installed on the Web-VV server.

15. A method for an automatic monitoring and control of at least one of a fill level and a pressure state with an inventory management system, comprising:
acquiring at least one of fill level data and pressure data by an inventory acquisition unit;
transmitting at least one of the fill level data and the pressure data from a communication unit to a central system using a communications system, the communication unit being assigned to the inventory acquisition unit;
receiving one of control data and regulating data with the communication unit from the central system using the communications network; and
centrally administrating and processing at least one of the fill level data and the pressure data by the central system.

16. The method according to claim 15, further comprising:
forwarding one of the processed fill level data and pressure data to a materials administration- and logistics control device for further processing.
